(19) United States
(12) Patent Application Publication
(10) Pub. No.: US 2009/0206167 A1
(43) Pub. Date: Aug. 20, 2009

(54) TEMPERATURE INDICATING APPARATUS

(75) Inventors: HU-FEI DENG, Shenzhen (CN); YONG-ZHAO HUANG, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/046,461

(22) Filed: Mar. 12, 2008

(30) Foreign Application Priority Data
Feb. 19, 2008 (CN) 200810300357.6

(51) Int. Cl. G05D 23/00

(52) U.S. Cl. 236/94

(57) ABSTRACT

A temperature indicating apparatus for indicating when temperature of a heat source exceeds a predetermined temperature includes an I/O controller, an A/D converter, a single chip microcomputer (SCM), and an indicating unit. The I/O controller outputs a temperature signal of the heat source. The A/D converter receives the temperature signal, and outputs a digital temperature signal. The SCM storing at least one predetermined temperature value, receives the digital temperature signal and converts the digital temperature signal to a temperature value, and outputs a control signal when the temperature value of the digital temperature signal exceeds the predetermined temperature value. The indicating unit includes at least one indicating lamp coupled to the SCM, the indicating lamp emits light when it receives the control signal from the SCM.

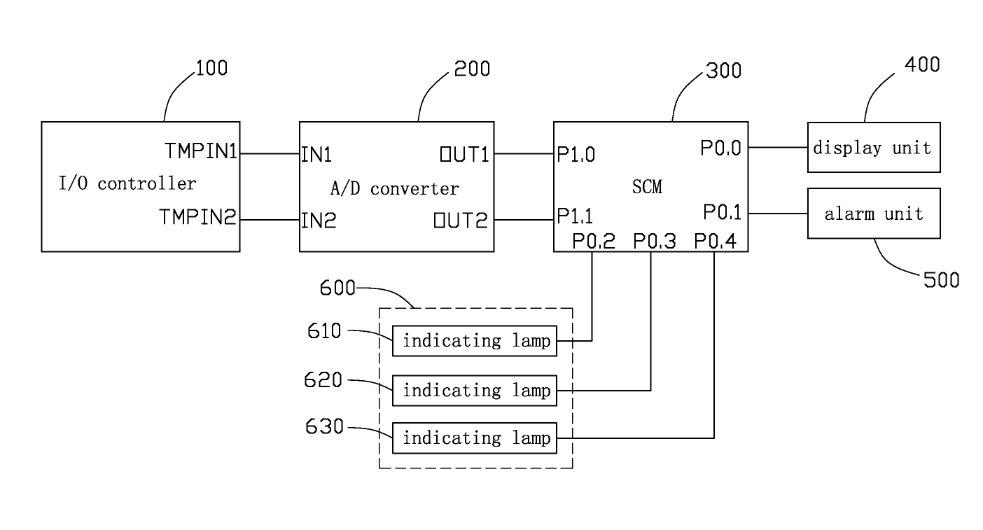

### BACKGROUND

1. Field of the Invention

The present invention relates to indicating apparatuses, and particularly to an indicating apparatus which can indicate when temperature of a heat source exceeds a predetermined temperature.

2. Description of related art

Developments in today's highly information-intensive society have led to remarkable improvements in performances of electronic devices. During operation of many contemporary electronic devices such as computers, central processing units (CPUs) therein produce large amounts of heat. Typically, one or more fans are used to facilitate removal of heat in a computer. The fans must be running stably, so as to prevent the computer from becoming unstable or being damaged. If the fans in a computer become unstable or even cease running, heat generated from the CPU in the computer will not be dissipated in time and may damage or ruin the CPUs.

What is needed, therefore, is to provide an indicating apparatus which can indicate when temperature of a heat source exceeds a predetermined temperature.

### SUMMARY

An exemplary temperature indicating apparatus for indicating when temperature of a heat source exceeds a predetermined temperature includes an I/O controller, an A/D converter, a Single Chip Microcomputer (SCM), and an indicating unit. The I/O controller outputs a temperature signal of the heat source. The A/D converter receives the temperature signal, and outputs a digital temperature signal. The SCM storing at least one predetermined temperature value, receives the digital temperature signal and converts the digital temperature signal to a temperature value, and outputs a control signal when the temperature value of the digital temperature signal exceeds the predetermined temperature value. The indicating unit includes at least one indicating lamp coupled to the SCM, the indicating lamp emits light when it receives the control signal from the SCM.

Other advantages and novel features of the present invention will become more apparent from the following detailed description of preferred embodiment when taken in conjunction with the accompanying drawing, in which:

### BRIEF DESCRIPTION OF THE DRAWING

The drawing is an schematic view of an embodiment of a temperature indicating apparatus in accordance with the present invention.

### DETAILED DESCRIPTIONS

Referring to the drawing, a temperature indicating apparatus in accordance with an embodiment of the present invention includes an I/O controller 100, an A/D converter 200, a single chip microcomputer (SCM) 300, a display unit 400, an alarm unit 500, and an indicating unit 600.

The I/O controller 100 is coupled to a south bridge on a motherboard of a computer, and includes two output terminals TMPIN1, TMPIN2 respectively outputting a system temperature signal and a CPU temperature signal. The A/D converter 200 includes two input terminals IN1, IN2 respectively receiving the system temperature signal and the CPU temperature signal, and two output terminals OUT1, OUT2 respectively outputting a digital system temperature signal and a digital CPU temperature signal.

The SCM 300 storing a plurality of predetermined temperature values, and includes two input terminals P1.0, P1.1 and five output terminals P0.0˜P0.4. The two input terminals P1.0, P1.1 respectively receive the digital system temperature signal and the digital CPU temperature signal. The SCM 300 converts the digital system temperature signal and the digital CPU temperature signal to temperature values, and outputs a control signal when either of the system temperature value and the CPU temperature value exceed any one of the predetermined temperature values.

The display unit 400 is coupled to the output terminal P0.0 of the SCM 300, and displays the system temperature and the CPU temperature. The alarm unit 500 is coupled to the output terminal P0.1 of the SCM 300, the SCM 300 activates the alarm unit 500 when either of the system temperature value and the CPU temperature value exceed the largest predetermined temperature value, which is equivalent to the maximum safe operating temperature of the system and the CPU. The indicating unit 600 includes three indicating lamps 610, 620, 630 respectively coupled to the output terminals P0.2˜P0.4 of the SCM 300, the indicating lamps 610, 620, 630 emit light when the corresponding output terminal of the SCM 300 outputs the control signal.

In this embodiment, the I/O controller 100, the A/D converter 200, the SCM 300, and the alarm unit 500 are disposed on the motherboard of the computer, the display unit 400 and the indicating lamps 610, 620, 630 are disposed on a front panel of the computer enclosure. The alarm unit 500 is a buzzer. The display unit 400 is a liquid crystal display panel. The indicating lamps 610, 620, 630 are respectively blue, yellow, and red light emitting diodes (LEDs).

The SCM 300 storing three predetermined temperature values T1, T2, T3. When both of the system temperature value and the CPU temperature value are lower than the predetermined temperature value T1, the indicating lamps 610, 620, 630 are off, the display unit 400 displays the system temperature and the CPU temperature. When either of the system temperature value and the CPU temperature value is higher than the predetermined temperature value T1 and lower than the predetermined temperature value T2, the blue indicating lamp 610 emits light, the display unit 400 displays the system temperature and the CPU temperature. When either of the system temperature value and the CPU temperature value is higher than the predetermined temperature value T2 and lower than the predetermined temperature value T3, the yellow indicating lamp 620 emits light, the display unit 400 displays the system temperature and the CPU temperature. When either of the system temperature value and the CPU temperature value is higher than the predetermined temperature value T3, the red indicating lamp 630 emits light, the display unit 400 displays the system temperature and the CPU temperature and the buzzer 500 is activated. In this way, for example, a user of the computer can be made aware of increasing temperatures in stages, with darkened LEDs meaning temperatures are safe, blue LED lit meaning temperatures slightly elevated, yellow LED lit meaning temperatures moderately elevated precautionary measures should be considered, and red LED lit and the buzzer 500 sounding meaning temperatures are dangerously high immediate action should be taken.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A temperature indicating apparatus for indicating temperature of at least one heat source, comprising:
an I/O controller configured for outputting a temperature signal of the heat source;
an A/D converter configured for receiving the temperature signal, and outputting a digital temperature signal;
a single chip microcomputer (SCM) storing at least one predetermined temperature value, the SCM receives the digital temperature signal and converts the digital temperature signal to a temperature value, and outputs a control signal when the temperature value of the digital temperature signal exceeds the predetermined temperature value; and
an indicating unit comprising at least one indicating lamp coupled to the SCM, the indicating lamp emits light when it receives the control signal from the SCM.

2. The temperature indicating apparatus as claimed in claim 1, further comprising a display unit coupled to the SCM, the display unit displaying the temperature of the heat source.

3. The temperature indicating apparatus as claimed in claim 2, wherein the display unit is a liquid crystal display panel.

4. The temperature indicating apparatus as claimed in claim 2, wherein the heat source is a CPU in a computer.

5. The temperature indicating apparatus as claimed in claim 1, wherein the SCM stores three different predetermined temperature values, the indicating unit comprises three indicating lamps of different colors corresponding to the three different predetermined temperature values, the corresponding indicating lamp emits light when the temperature value of the heat source exceeds any one of the predetermined temperature values.

6. The temperature indicating apparatus as claimed in claim 5, further comprising an alarm unit coupled to the SCM, the SCM activates the alarm unit when the temperature value of the heat source exceeds the largest predetermined temperature value.

7. The temperature indicating apparatus as claimed in claim 6, wherein the alarm unit is a buzzer.

8. The temperature indicating apparatus as claimed in claim 5, wherein the indicating lamps are LEDs.
